(19) United States
(12) Patent Application Publication
(10) Pub. No.: US 2005/0266864 A1
(43) Pub. Date: Dec. 1, 2005

(54) Non-intrusive network architecture for mass mobile messaging

(76) Inventors: Xuming Chen, San Ramon, CA (US); Xiaomei Wang, Walnut Creek, CA (US)

Correspondence Address: DARBY & DARBY P.C., P. O. BOX 5257, NEW YORK, NY, 10150-5257, US

(21) Appl. No.: 10/858,635

(22) Filed: Jun. 1, 2004

(51) Int. Cl. H04M 3/00

(52) U.S. Cl. 455/466; 455/445

(57) ABSTRACT

A method and system for facilitating the transmission and delivery of mobile messages during a mass mobile messaging event. Dedicated message centers and messaging gateways are provided to route mobile messages associated with mass messaging events to and from their intended destinations. Such a configuration avoids the creation of undue latencies in the delivery of mobile messages that are not associated with mobile messaging events while providing an efficient mechanism to facilitate mass mobile messaging.

### FIELD OF INVENTION

The present invention relates generally to mobile messaging services and, more particularly, to a system and method for effective provisioning of additional message centers and other messaging network components to support mass mobile messaging.

### BACKGROUND

The Short Message Service (SMS) is an example of a mobile data service that facilitates the exchange of short alphanumeric messages between a cellular mobile system, such as that operated by Verizon Wireless, and SMS-capable mobile devices such as mobile phones and PDAs. In addition to voice capabilities, most presently available mobile phones include mobile messaging capability. Mobile messaging allows a mobile subscriber to send and receive alphanumeric text and multi-media-based messages using the subscriber's messaging-capable mobile handset. For example, as is known in the art, Nokia®, Ericcson®, Kyocera®, and Samnsung® each manufacture mobile phones which allow a wireless subscriber to send and receive SMS messages in an IS-95-based Code Division Multiple Access (CDMA) system in accordance with TIA/EIA-637-A or B, which are hereby incorporated herein by reference in their entirety. Mobile messaging capability is also available for mobile handsets operating in wireless networks other than CDMA-based networks, such as IS-136-based TDMA networks and GSM-based systems, as well as in other more advanced 2.5G and 3G mobile systems.

U.S. patent application Ser. No. 60/353,824 (hereinafter, “the '824 application”), entitled “System and Method for a Messaging Gateway,” which is hereby incorporated herein by reference in its entirety, discusses utilizing a Short Message Peer to Peer (hereinafter, “SMPP”) protocol enterprise gateway for providing a concentrated point of access to an SMS-based messaging network from a plurality of non-mobile external short message entities (hereinafter, “ESMEs”). SMPP protocol specification version 5 published by the SMS Forum Group and available at www.smsforum.net also discusses use and operation of an SMPP enterprise gateway. As is known in the art, an SMPP enterprise gateway (hereinafter, the “SMPP gateway”) centralizes access and processing of SMS messaging between third party ESMEs and messaging centers such as the Short Message Service Center (hereinafter, “SMSC”) of the SMS network and, accordingly, promotes efficient use of ESME and SMSC resources. The SMPP gateway forms a direct logical connection between the various ESMEs and one or more SMSCs. The ESMEs are typically owned and operated by third party vendors who are not affiliated with the wireless carrier, i.e., the ESME operator is not under the operational control of the owner and operator of the SMSCs. As is known in the art, ESMEs provide and/or facilitate third-party messaging services and other services such as voice mail alerting, utility meter reading and news and information retrieval and alerts.

As is further known in the art, an SMPP gateway may coordinate authentication and authorization of the ESMEs' respective access to the SMS network, provide service link management for the ESMEs and SMSCs, manage routing of SMS messages to the proper devices and handle SMSC message queuing, database storage, usage charge provisioning, establishment of virtual private networks and load balancing for the SMSCs.

Unfortunately, even with the use of one or more SMPP gateways, SMS mobile messaging may still be prone to significant latencies and/or packet losses when a higher than normal volume of wireless subscribers submit (i.e., originates) and/or receive (i.e., terminates) SMS messages all within the same time frame (hereinafter referred to as “mass messaging”). As an example, the gaining popularity of mobile messaging and its use during television broadcasts, allowing viewers to submit voting data via their wireless handsets, has created a need for a non-intrusive network architecture to handle mass mobile messaging. Other examples of mass mobile messaging events and applications include news and weather alerts, multimedia messaging services, presence updating for push-to-talk and instant messaging applications, WAP push, push-to-show services and group broadcast messaging.

Typically, during periods of mass messaging, more mobile messages are being introduced into or sent from the SMS network than the number of available SMPP gateways and SMSCs can support. Accordingly, multiple ESMEs are forced to compete for the resources of the overloaded SMPP gateways and the SMSCs to which SMPP gateways are connected. Under such conditions, the SMPP gateways and SMSCs would normally attempt to route the communications to other SMSCs or SMPP gateways in the network, however, this will provide little resolve because the back-up felt on network components during periods of mass messaging is equally felt throughout the entire network and is not specific to one particular SMSC or SMPP gateway. As a result, the SMPP gateways and SMSCs are often forced to drop their connection with the ESME or place the communication in a queue until the SMPP gateway or SMSC is again available. All of these steps drain the resources of the SMPP gateway and SMSC, and degrade overall performance of the mobile messaging service.

The mobile messages that cannot be immediately routed through the mobile messaging network or to the ESMEs are eventually queued by an SMPP gateway or SMSC until they are available to process them. Holding a mobile message in the messaging network introduces a delay in message delivery. When a higher than normal number of mobile messages are being processed (i.e., mass mobile messaging), the delay is compounded and the load on the messaging network is increased, thus adversely affecting not only delivery of mobile messages associated with a mass messaging event, but also delivery of other mobile messages not associated with a mass messaging event. During periods of mass SMS messaging delays in message delivery may be so significant that messages are eventually dropped from the network all together (i.e., message timeout).

As described above, during periods of mass messaging, both originating and terminating with a subscriber, normal messaging traffic can be prone to significant latencies and/or packet losses. Therefore, it would be advantageous to provide a messaging system that does not cause undue latency and/or packet losses during periods of mass mobile messaging while also allowing for minimal changes to currently operational SMPP gateways and SMSCs.

Accordingly, what is desired is a system and method for facilitating mass mobile messaging communications between one or more ESMEs and one or more SMSCs.

### SUMMARY

The present invention provides a method and system for facilitating prepaid mobile messaging which avoids latency and/or packet losses during periods of mass mobile messaging by controlling the flow of mass mobile message traffic between a short message service center of a wireless network and an external short messaging entity located external to the wireless network. An exemplary embodiment of the method includes the steps of: (1) receiving packetized data at a short message service center, the packetized data including information to facilitate delivery of a mobile message; (2) determining the intended destination of the mobile message based on information contained in the data received at the short message service center, and if the destination is identified as an external short messaging entity operable for transmitting and receiving mass mobile messages, identifying the message as a mass mobile message and sending the mobile message to a mobile messaging gateway specifically operable to process and route mass mobile messages, the mobile messaging gateway being disposed between the short message service center and the external short messaging entity; and (3) sending the mobile message from the mobile messaging gateway to its intended destination.

Another exemplary method of the invention includes the steps of: (1) receiving packetized data associated with a mobile message at a mobile messaging gateway dedicated to routing mobile messages associated with mass messaging events, the packetized data including information to facilitate delivery of the associated mobile message; (2) determining the intended destination of the associated mobile message utilizing the data; (3) sending the associated mobile message to a short message service center dedicated to routing mobile messages associated with mass messaging events; and (4) sending the mobile message from the short message service center on to its intended destination.

An exemplary system of the present invention includes one or more short message service centers for routing a mobile SMS message associated with one or more mobile messaging subscribers wherein the one or more short message service centers are programmed to receive packetized data from a wireless network. The packetized data includes information to facilitate delivery of the mobile message. The short message service centers are programmed to reference the packetized data to determine if the message is associated with a mass messaging event.

The short message service centers routes a non-associated SMS message to a first mobile messaging gateway and an associated SMS message to a second mobile messaging gateway, wherein the second mobile messaging gateway is configured to process and route only associated mobile messages.

### BRIEF DESCRIPTION OF THE DRAWINGS

The foregoing features of the present invention will be more readily apparent from the following detailed description and drawings of an illustrative embodiment of the invention in which:

FIG. 1 is a block diagram illustrating a prior art system of interconnected ESMEs and SMSCs as well as various components of a wireless cellular network;

FIG. 2 is a block diagram illustrating a system of interconnected ESMEs and SMSCs in accordance with an illustrative embodiment of the present invention;

FIG. 3 illustrates, in flow chart format, an illustrative embodiment of a method for processing mass mobile terminating messages in accordance with the present invention; and

FIG. 4 illustrates, in flow chart format, another illustrative embodiment of a method for processing mass mobile originating messages in accordance with the present invention.

### DETAILED DESCRIPTION OF AN EMBODIMENT OF THE INVENTION

The present invention described herein includes a system and method for providing a non-intrusive network architecture for facilitating mass mobile messaging that relieves undue latency to the mobile messaging network and that does not otherwise adversely affect overall message delivery rates and/or message success rates.

The exemplary embodiment described herein references a mobile messaging network operating in accordance with TIA/EIA-637 A or B, known as the Short Message Service (SMS). Although the exemplary embodiment is described with reference to SMS messaging, it is understood that the present invention may be utilized by any mobile messaging system utilizing any known protocols and/or standards for mobile messaging. It is further understood that the present invention is applicable to any known wireless network carrier standards such as 2G, 2.5G and 3G wireless standards and their variations, e.g., CDMA, CDMA2000, TDMA and GSM.

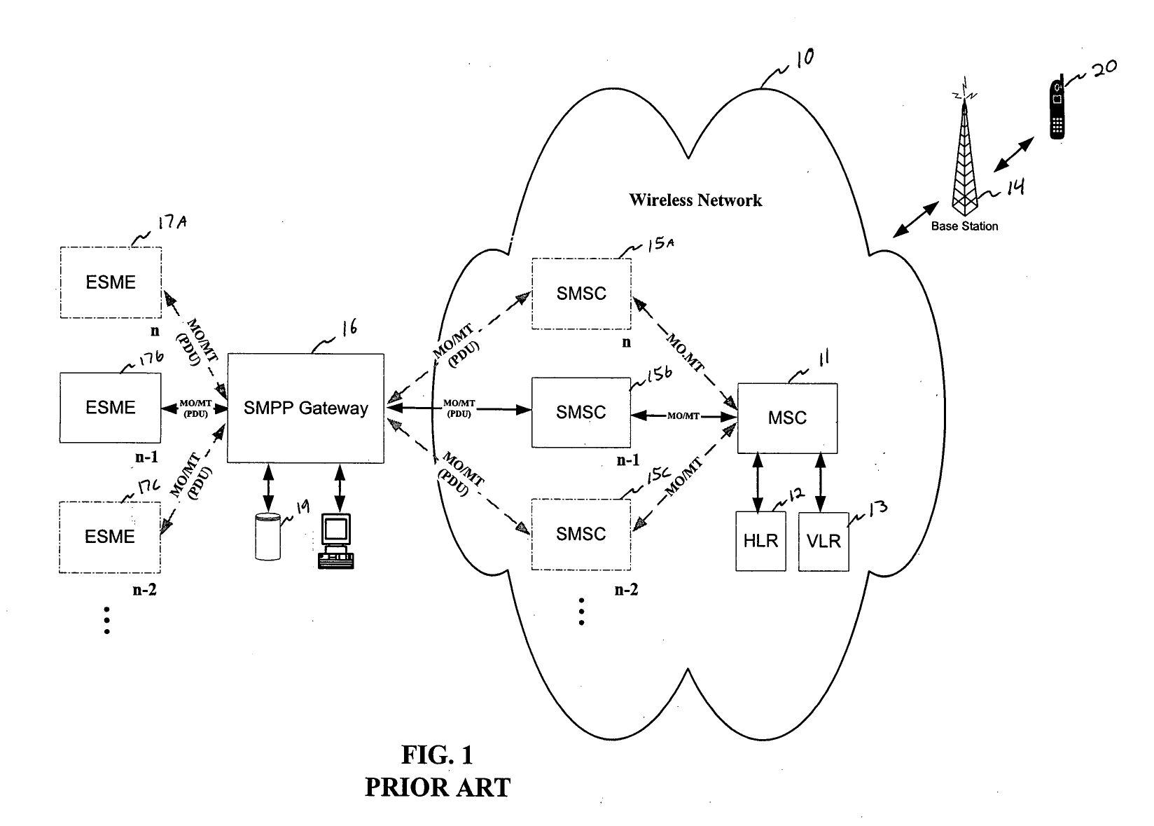

FIG. 1 illustrates a known wireless network 10 including an associated SMS messaging system. Wireless network 10 includes components of a mobile messaging network to facilitate delivery and transmission of SMS messages to and from SMS-capable devices, e.g., mobile telephone 20 and messaging-capable PDAs. Wireless network 10 also includes all the known components that constitute a wireless network, including mobile switching centers 11 (MSCs), home location registers 12 (HLR), visitor location registers 13 (VLR) and base stations 14, which together allow an SMS-capable mobile handset 20 to communicate with other communication devices using known voice and data formats.

The SMS messaging system of FIG. 1 includes mobile message centers, e.g., Short Messaging Service Centers (SMSCs 15a, 15b and 15c) which receive, store, route and forward SMS messages for SMS-capable mobile handset 20 and other devices capable of communicating via SMS messaging. As is known in the art, each mobile subscriber is assigned a “home” SMSC which is principally responsible for routing SMS messages to and from that particular subscriber. While only three SMSCs (15a, 15b and 15c) are illustrated in FIG. 1, it is understood that wireless network 10 may include any number of multiple interconnected SMSCs to facilitate mobile message functionality over wide geographic areas and for large subscriber bases.

MSC 11 is connected to a HLR 12. HLR 12 can be utilized by MSC 11, as well as by SMSCs 15a, 15b and 15c, in wireless network 10 to track the registered location of subscriber's mobile handsets thus facilitating delivery of mobile messages to the subscriber's handset 20. Additionally, HLR 12 maintains information about network subscribers including voice services, and the respective features and services associated with and available to the subscribers. As an example, HLR 12 includes information as to whether a user has subscribed to three way calling, voice mail or Internet data services. Although not illustrated, it is understood that wireless network 10 may include multiple HLRs each respectively servicing multiple MSCs and SMSCs. Moreover, it is understood that HLR 12 may service multiple other MSCs in addition to MSC 11.

SMPP Enterprise gateway (hereinafter “SMPP gateway 16”) is coupled between multiple SMSCs 15a, 15b and 15c and one or more application messaging platforms known as External Messaging Service Entities 17a, 17b and 17c (hereinafter “ESMEs”) that are located external to the SMS network. Commercially available SMPP gateways include the Motorola SMS Gateway. SMPP gateway 16 operates utilizing the SMPP protocol although other protocols known in the art providing the same or similar functionality may also be used. The SMPP protocol facilitates communications with ESMEs 17a, 17b and 17c and enables ESMEs 17a, 17b and 17c to interface with SMPP gateway 16, through which ESMEs 17a, 17b and 17c can communicate with SMSCs 15a, 15b and 15c and SMS capable mobile devices.

SMPP is a packet-based protocol. More particularly, ESMEs, SMPP gateways and SMSCs use SMPP to communicate via packets known as protocol data units (hereinafter, “PDUs”). PDUs are utilized to define the session state of communications between an SMPP “PDUs”). PDUs are utilized to define the session state of communications between an SMPP gateway and an ESME or SMSC (e.g., whether an “open” communication channel exists between the devices). Additionally, PDUs transport requests relating to messaging between the devices. For example, certain predefined requests are utilized to send SMS messages to and from an ESME, substitute or cancel pending SMS messages and query the status of the SMS message in the SMS network.

Although SMPP gateway 16 is shown connected to only three SMSCs in FIG. 1, it is understood that SMPP gateway 16 may interconnect to multiple ESMEs and SMSCs. As is known in the art, an SMPP gateway facilitates communications between ESMEs and SMSCs by acting as a concentrated point of access to the SMS network for the various ESMEs.

The messaging network illustrated in FIG. 1 facilitates transport of mobile originated (MO) messages, i.e., messages sent from a mobile device, as well as mobile terminated (MT) messages, i.e., messages sent to a mobile device. As is known in the art, MO and MT messages generally include data identifying the originating and destination addresses of the message. As is further known in the art, each of SMSCs 15a, 15b and 15c, SMPP gateway 16 and ESMEs 17a, 17b and 17c include routing tables. To facilitate proper delivery of each mobile message, each time an MO or MT message is received at the particular device the routing tables are referenced in conjunction with the originating and destination address associated with the MO or MT message.

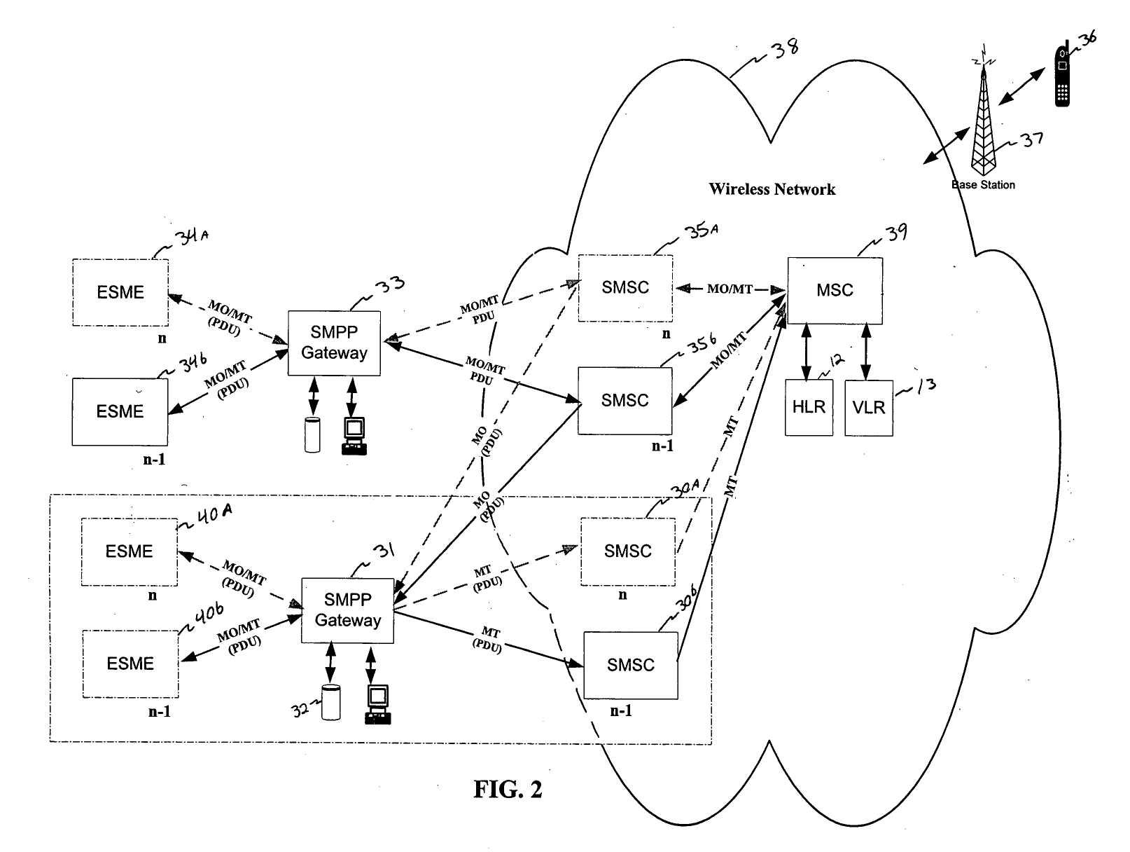

FIG. 2 illustrates an illustrative embodiment of an SMS network configured in accordance with the present invention. In the SMS network illustrated in FIG. 2, supplemental SMSCs 30a and 30b and supplemental SMPP gateway 31 are provided for the purpose of facilitating the routing of SMS mass messaging traffic.

According to the preferred embodiment, normal SMS message traffic, i.e., SMS message traffic not associated with a mass messaging event, proceeds through the SMS network in the normal manner, whereby SMPP gateway 33 and, possibly, other SMPP gateways (not illustrated) acts as a concentrated point of access to the SMS network, thus facilitating communications between ESMEs 34a and 34b and, possibly, other ESMEs (not illustrated) and SMSCs 35a and 35b and, possibly, other SMSCs (not illustrated) as in prior art systems described above.

However, for MO and MT messages that are pre-determined to be related to mass messaging events and applications, supplemental SMSCs 30a and 30b and SMPP gateway 31 are utilized to shift the traffic load associated with MO and MT mass messaging away from the normal messaging traffic. Also, as illustrated in FIG. 2, ESMEs 40a and 40b, which are associated with mass messaging events, are logically segregated from ESMEs 34a and 34b which do not generally engage in mass messaging events.

With continued reference to the illustration of FIG. 2, the system is programmed to operate as follows. The routing tables of all SMSCs in the messaging network, except for supplemental SMSCs 30a and 30b, are programmed to read the destination address of MO messages as they are received. If the destination address is an address associated with a mass messaging application, a PDU containing the MO message is routed via SMPP to supplemental gateway 31. Supplemental gateway 31, which is responsible for routing MO messages associated with mass messaging applications, will then route the PDU containing the MO message to the appropriate one of ESME 40a and 40b.

One of ordinary skill in the art will readily appreciate the benefit of the above-described configuration for routing SMS MO messages in that both normal and mass MO messages continue to utilize the home SMSC associated with the originating subscriber. All that is preferably required is an adjustment in the ability of SMSCs 35a and 35b to identify and properly route an MO mass message, which may be accomplished by a configuration of the routing table associated with SMSCs 35a and 35b. Preferably, the respective routing tables of SMSCs 35a and 35b will be programmed to forward MO messages associated with mass messaging events to supplemental gateway 31 based on the destination address of the MO messages.

As for MT messages associated with mass messaging applications and events, in the preferred embodiment of the present invention, any and all ESMEs that send MT messages associated with mass messaging events are programmed to forward, via SMPP, PDUs containing MT mass messages only to supplemental SMPP gateway 31. Preferably, as shown in FIG. 2, ESMEs that engage in mass messaging (ESMEs 40a and 40b) have SMPP connections only to SMPP gateway 31.

SMPP gateway 31, in turn, is programmed to forward all MT messages via SMPP to one of supplemental SMSCs 30a and 30b as appropriate. SMSCs 30a and 30b are programmed to then route the mass MT messages in the normal manner. SMSCs 30a and 30b can be configured to provide redundancy so that MT messages can be routed to either of these MT only SMSCs. Thus, in the event one of SMSC 30a and 30b is down (unable to receive MT messages), the other MT only SMSC can continue to perform the mobile termination.

One skilled in the art will appreciate that the additional loads on the messaging network that might otherwise be caused during periods of mass SMS MT messaging will be alleviated by sending mass MT messaging traffic directly to supplemental SMSCs 30a and 30b, rather than to the existing SMSCs 35a and 35b of the messaging network. By keeping mass MT messaging traffic away from the routing path of normal MT messaging traffic, the undue latencies and packet losses discussed above with regard to the prior art system are avoided.

In the preferred embodiment, SMSCs 30a and 30b are programmed to attempt delivery of MT messages with at most one retry. Any message which can not be successfully delivered with at most one retry will be discarded by the SMSC. One skilled in the art will appreciate that variations in re-try attempts may be desired and accomplished depending on various factors, including the application associated with the mass MT message. Moreover, SMSCs 30a and 30b are programmed to avoid setting a message pending flag at the HLR or MSC of the intended recipient of a mass MT message in order to avoid unnecessary latency in the overall message delivery system.

As noted above, in the preferred embodiment, supplemental SMPP gateway 31 is functionally similar to SMPP gateway 33, however, supplemental SMPP gateway 31 has the isolated task of routing only SMS messages identified to be mass messages, thereby alleviating stress otherwise felt by SMPP gateway 33 in the network. SMPP gateway 31 otherwise functions in the normal manner, utilizing existing routing tables to determine the destination ESME for a received PDU containing a mass MO message or to determine which SMSC a received PDU containing a mass MT message should be sent.

As further illustrated in FIG. 2 the arrows between the respective devices logically illustrate the general flow of message information. Thus, the one-way arrows between supplemental gateway 31 and SMSCs 30a and 30b indicate a one way flow of messages from the SMPP gateway to an SMSC for purposes of transmitting mass MT messages. The illustration of the two-way arrows between SMPP gateway 33 and SMSCs 35a and 35b indicate a two-way information flow whereby gateway 33 can send and receive information (MT and MO messages) to and from SMSCs 35a and 35b.

ESMEs 40a and 40b that send and receive mobile messages associated with mass messaging events are logically segregated from ESMEs 34a and 34b which do not generally engage in mass messaging events. ESMEs 40a and 40b are programmed to forward, via SMPP, PDUs containing MT mass messages only to supplemental SMPP gateway 31. Accordingly, ESMEs 40a and 40b have SMPP connections only to SMPP gateway 31. In a similar manner, ESMEs 34a and 34b send and receive mobile messages associated with normal messaging events and thus are programmed to forward, via SMPP, PDUs containing MT messages to SMPP gateway 33. The segregation of ESMEs 40 from ESMEs 34 provides supplemental SMPP gateway 31 the isolated task of routing SMS messages relating to ESMEs designated to send and receive mass mobile messages (ESMEs 40a and 40b), thereby alleviating stress otherwise felt by SMPP gateway 33 and SMSCs 35 in the network.

One skilled in the art will appreciate that the above-described segregation of ESMEs 40a and 40b is meant to denote a logical segregation. A single ESME hardware device may have multiple respective connections for both mass mobile messaging traffic connecting to supplemental SMPP gateway 31 as well as regular mobile messaging traffic connecting to SMPP gateway 33. Moreover, a single application resident on an ESME may have connections to both supplemental SMPP gateway 31 and to SMPP gateway 33 so that it may at certain times engage in mass mobile messaging while at other times engage only in regular mobile messaging.

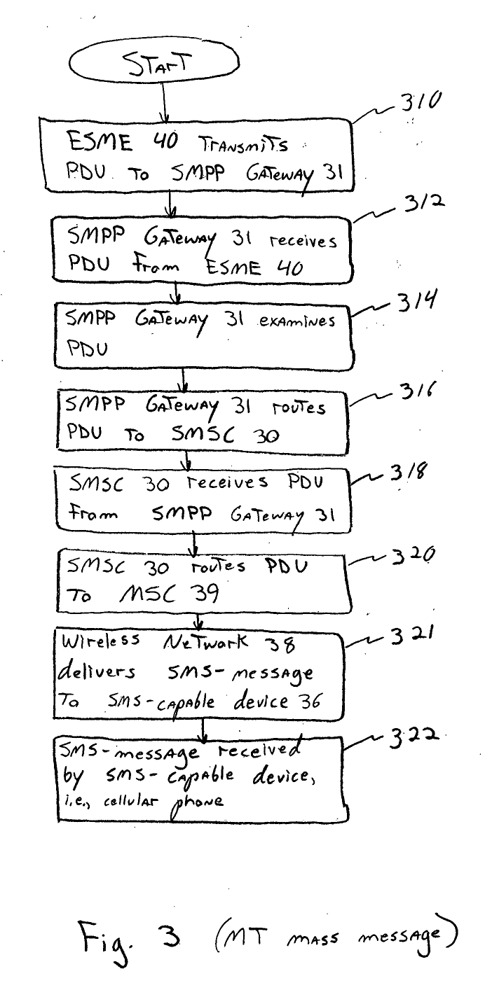

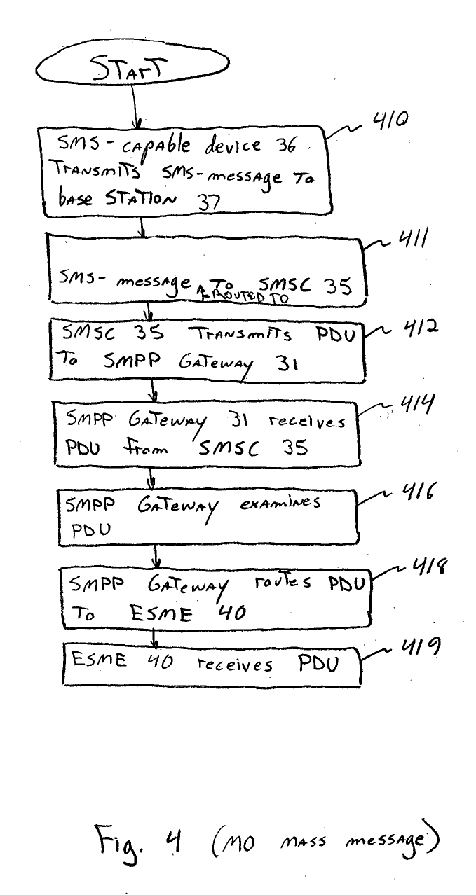

FIG. 3 represents, in flow chart format, a method by which an SMS network configured according to FIG. 2 operates for processing MT SMS messages. Proper connection, session requests and acknowledgements between ESMEs 34 and 40, SMPP gateways 31 and 33 and SMSCs 35 and 30, prior to the exchange of an SMS message, although not illustrated in FIGS. 3 and 4, shall be assumed to be within the scope of one of ordinary skill in the art.

At step 310, ESME 40 transmits a PDU containing a mass MT SMS message to supplemental SMPP gateway 31. Gateway 31 receives an inbound PDU from ESME 40 (understood to be one of ESME 40a and 40b) at step 312 and at step 314 examines the received PDU and determines its route utilizing routing tables. At step 316, SMPP gateway 31 forwards the PDU to an appropriate supplemental SMSC 30 of wireless network 38 (understood to be one of SMSCs 30a and 30b) based on the determined route. Next, at step 318, SMSC 30 receives the PDU and at step 320 routes it to MSC 39. At step 321 the wireless network delivers the MT message to SMS-capable device 36 via base station 37. The transmission completes with SMS capable device 36 receiving the intended SMS message (step 322).

FIG. 4 represents, in flow chart format, a method by which an SMS network according to FIG. 2 operates for processing MO SMS messages. The process begins at step 410, with SMS-capable device 36 transmitting an SMS message to base station 37 of wireless network 38. At step 411, the SMS message is routed through wireless network 38 to SMSC 35 (understood to be one of SMSCs 35a and 35b) Next, at step 412, SMSC 35 examines the MO message's destination address, determining whether the SMS message should be routed and processed as a mass SMS message or a regular SMS message. As discussed above, this determination is made based on the pre-programmed routing table of SMSC 35. If a determination is made that the message is a mass message, the MO message is forwarded to supplemental SMPP gateway 31 operable for processing and routing mass MO messages. At step 414, gateway 31 receives, via SMPP, a PDU containing the mass MO message from SMSC 35. At step 416, supplemental gateway 31 examines the destination address of the mass MO message received at step 414. At step 418, a route for the PDU containing the mass MO message is determined by consulting routing tables included in database 32 of gateway 31 and the PDU is forwarded to an ESME 40 according to the determined route. The process concludes at step 419 when the PDU containing the mass MO message is received by ESME 40.

Although the above-described embodiments of the present invention utilize only a single supplemental gateway 31, it is understood that multiple gateways may be utilized to provide for multiple site redundancy, fault tolerance and load balancing among the gateways in accordance with known methods in the art. Moreover, multiple and/or redundant ESMEs belonging to the same third party provider may be connected to gateway 31 to similarly provide redundancy, fault tolerance and load balancing among the ESMEs. Additionally, MO messages will be received by the MSC that controls the coverage area that the mobile device 36 is in at any given time and MO messages are sent by this MSC to the home SMSC of the sending subscriber.

One skilled in the art will appreciate that additional variations may be made in the above-described embodiment of the present invention without departing from the spirit and scope of the invention which is defined by the claims which follow. We claim:

1. A method for controlling the flow of mass mobile message traffic between a short message service center of a wireless network and an external short messaging entity dedicated to mass mobile messaging, the method comprising the steps of:
receiving a mobile message at a short message service center, the mobile message including destination information;
referencing a routing table utilizing the destination information of the mobile message;
sending the mobile message to a messaging gateway dedicated to routing mobile messages associated with mass messaging events, the mobile messaging gateway being disposed between the short message service center and an external short messaging entity; and
sending the mobile message from the mobile messaging gateway to the external short messaging entity dedicated to mass mobile messaging.

2. The method of claim 1, wherein the mobile message is originated by a wireless device.

3. The method of claim 1, wherein the routing table is associated with the short message service center.

4. The method of claim 1, wherein the routing table associates certain destination information with mass messaging events.

5. The method of claim 4, wherein said association is accomplished by routing messages with certain destination information to the messaging gateway dedicated to routing mobile messages.

6. The method of claim 1, wherein the mobile message is sent from the short message service center to the messaging gateway dedicated to routing mobile messages using the Short Message Peer to Peer protocol.

7. A method for routing one of a regular mobile terminating message and a mass mobile terminating message, the method comprising the steps of:
receiving a regular mobile terminating message, at a first mobile messaging gateway, the mobile messaging gateway being disposed between a first external short messaging entity and a first short message service center;
receiving a mass mobile terminating message, at a second mobile messaging gateway, the mobile messaging gateway being disposed between a second external short messaging entity and a second short message service center;
sending the regular mobile terminating message to the first short message service center, the first short message service center disposed between the first mobile messaging gateway and a wireless subscriber device and operable to process regular mobile messages; and
sending the mass mobile terminating message to the second short message service center, the second short message service center disposed between the second mobile messaging gateway and a wireless subscriber and dedicated to processing mass mobile messages.

8. A method for routing wireless mobile terminated messages associated with mass messaging events, comprising the steps of:
sending a mobile terminated message from an external short messaging entity to a mobile messaging gateway dedicated to routing mobile messages that are associated with mass messaging events; and
sending the mobile terminated message from the mobile messaging gateway to a short message service center dedicated to routing mobile messages that are associated with mass messaging events.

9. The method of claim 8, further comprising the step of sending the mobile terminated message to its intended destination.

10. The method of claim 8, wherein the short message service center routes only mobile terminated messages associated with mass messaging event.

11. The method of claim 8, wherein a mobile terminated message is sent to one of at least two short message service centers dedicated to routing mobile messages that are associated with mass messaging events thereby providing the short message service center with redundancy.

12. The method of claim 8, wherein the mobile terminated message is sent from the external short messaging entity to the mobile messaging gateway using the Short Message Peer to Peer protocol.

13. The method of claim 8, whereupon the short message service center's failure to successfully deliver the mobile terminated message to the intended destination, a limited and predetermined number of subsequent deliveries are attempted.

14. The method of claim 8, whereupon the short message service center's failure to successfully deliver the mobile message to the intended destination, no subsequent deliveries are attempted.

15. The method of claim 8, wherein one or more of an HLR and MSC associated with the short message service center do not set their respective message pending flags upon the short message center receiving the short message.

16. A system for providing mobile messaging between a short message service center of a wireless network and an external short messaging entity located external to the wireless network, comprising:
one or more short message service centers for routing a mobile message, the mobile message being associated with a mobile messaging subscriber, the one or more short message service centers being programmed to receive data from a wireless network including information to facilitate delivery of the mobile message, and to reference the data to determine if the message is associated with a mass messaging event; and
said one or more short message service centers being further programmed to route a non-associated message to a first mobile messaging gateway and an associated message to a second mobile messaging gateway, wherein the second mobile messaging gateway is dedicated to routing associated mobile messages.

17. The system of claim 16 wherein said first and second mobile messaging gateways are disposed between said one or more short message service centers and one or more external short messaging entities, whereby said first and second mobile messaging gateways route the mobile message to the one or more external short messaging entities.

18. The system of claim 17, further including at least one additional short message center, the additional short message center being programmed to receive from the second mobile messaging gateway, associated mobile messages destined for a mobile messaging subscriber.

19. A system for routing mobile messages comprising a short message center dedicated to routing mobile terminating messages associated with mass messaging events.

20. A system for routing mobile messages comprising a mobile messaging gateway dedicated to routing mobile messages associated with mass messaging events.
